(19) United States
(12) Patent Application Publication
(10) Pub. No.: US 2015/0179363 A1
(43) Pub. Date: Jun. 25, 2015

(54) DEVICE FOR THE SAFE SWITCHING OF A PHOTOVOLTAIC SYSTEM

(71) Applicant: ELLENBERGER & POENSGEN GMBH, ALTDORF (DE)

(72) Inventors: MARKUS WIERSCH, ALTDORF (DE); HUBERT HARRER, HILPOLTSTEIN (DE); WALDEMAR WEBER, NUERNBERG (DE)

(21) Appl. No.: 14/604,900

(22) Filed: Jan. 26, 2015

Related U.S. Application Data
(63) Continuation of application No. PCT/EP2013/002034, filed on Jul. 11, 2013.

(30) Foreign Application Priority Data
Jul. 26, 2012 (DE) 202012007257.9

(51) Int. Cl. H01H 9/02; H01H 9/50

(52) U.S. Cl. CPC H01H 9/0271; H01H 9/50

(57) ABSTRACT

A device safely switches a photovoltaic system and has a circuit breaker with input terminals and output terminals. The circuit breaker is configured as a switching module that includes a module housing and a switch contact arranged inside the housing for isolating at least one current path between one of the input terminals and one of the output terminals. A modular current sensor is provided which is to be mounted on the module housing of the circuit breaker.

### CROSS-REFERENCE TO RELATED APPLICATION

This is a continuation application, under 35 U.S.C. §120, of copending international application No. PCT/EP2013/002034, filed Jul. 11, 2013, which designated the United States; this application also claims the priority, under 35 U.S.C. §119, of German patent application No. DE 20 2012 007 257.9, filed Jul. 26, 2012; the prior applications are herewith incorporated by reference in their entireties.

### BACKGROUND OF THE INVENTION

### Field of the Invention

The invention relates to an apparatus for the safe switching of a photovoltaic system (PV system) that contains an isolating switch having input connectors for connecting to a number of mutually connected photovoltaic modules (PV modules) and the isolating switch having output connectors for connecting an inverter.

Published, non-prosecuted German patent application DE 10 2011 008 140 A1 (corresponding to U.S. patent publication No. 2013/0170084) discloses a method and an apparatus for the safe switching of a photovoltaic system in the event of an electric arc occurring on the direct current side. The known apparatus contains an inverter and an electric arc sensor that is connected to a control unit for power guidance and is positioned on the direct current-side of the inverter. In the event of an electric arc being detected by a sensor, the control unit initiates an adjustment of the power guidance. In the case of the electric arc being classified as a series electric arc the control unit initiates a direct current-side isolation by an isolating switch that is connected in series upstream of the transformer and in the case of the electric arc being classified as a parallel electric arc the control unit initiates a direct current-side short circuit of the transformer by a short circuit switch that is connected in parallel to the transformer.

Published, non-prosecuted German patent application DE 10 2009 022 508 A1 (corresponding to U.S. patent publication No. 2010/0326809) discloses a switching system for a photovoltaic system. A switching mechanism, for opening contact points, and also a bypass are provided in the supply lines that are routed to two connectors, the bypass being arranged between the two connectors and upstream of the switching mechanism and the bypass itself containing a switching mechanism for closing contact points. The switching mechanisms are coupled to one another in such a manner that as the switching system is actuated initially the contact points of the switching mechanism in the two supply lines are opened and subsequently the contact points of the switching mechanism in the bypass are closed with a time delay. The known switching system is used in particular during operations of a fire brigade for the purpose of switching the photovoltaic system to zero current or a de-energized state in order to prevent injury as a result of electric shocks or electric arcs in the event of extinguishing agents being used.

It is known from published, European patent application EP 2 315 328 A2 (corresponding to U.S. patent publication No. 2011/0090607) to provide a protective device in each of a number of strings having series-connected photovoltaic modules of a photovoltaic system both in the positive current path and also in the negative current path and the protective device contains an over current protector, an arc fault protector, a reverse current protector and/or a ground fault protector.

International patent disclosure WO 2005/098458 A1 discloses a current sensor for detecting current changes that have a particularly steep rising edge and the current sensor contains a ferro-magnetic coupling element and a sensor winding, which surrounds the coupling element with a number of secondary windings, and also an exciter winding that is conveying current. The known current sensor is used to detect current changes that occur as a result of electric arc faults.

In order to evaluate rapid current changes as a result of electric arc faults, it is known from published, non-prosecuted German patent application DE 10 2007 013 712 A1 (corresponding to U.S. Pat. No. 7,834,614) to generate a time-differentiated sensor signal, which has a sensor-dependent frequency band width, using in turn a current sensor from a sensor winding and an exciter winding that is wound with the sensor winding around a common coupling element. An evaluation signal that is generated from the sensor signal is compared with a threshold value, wherein a standardized signal is generated and the pulse duration of the standardized signal is extended to a predetermined time value.

German utility model DE 20 2009 004 198 U1 discloses an isolating device for interrupting the direct current supply between a photovoltaic generator and an inverter. The isolating device contains a current-conveying mechanical switch and a semi-conductor electronic unit that is connected in parallel thereto. In the event of the mechanical switch opening as a result of an electric arc fault, the electric arc voltage that is generated by way of the switch switches the semi-conductor electronic unit to conduct current, the semi-conductor electronic unit does not conduct current when the mechanical switch is closed.

### SUMMARY OF THE INVENTION

The object of the invention is to provide a particularly suitable apparatus for the safe switching of a photovoltaic system.

The apparatus in accordance with the invention contains an isolating switch having input connectors for connecting to a number of mutually connected photovoltaic modules of a photovoltaic system and having output connectors for connecting in particular to an inverter. The isolating switch is embodied as a switching module and contains a module housing having within the housing at least one switching contact for interrupting the current path between one of the input connectors and one of the output connectors. Furthermore, a modular current sensor is provided that is configured so as to be mounted on the module housing of the isolating switch. The current sensor can be arranged both in the positive current path and also in the negative current path.

The current sensor is preferably provided and configured so as to detect in a contact-free or galvanic manner the current that is flowing along the current path. It is particularly preferred that the current sensor is a so-called direct-display current sensor having an annular core and a measuring winding or a Hall sensor. An essential element of the current sensor is the annular core. The annular core can be embodied in accordance with a type of Rogowski coil, in particular for detecting the rate of current change (di/dt) or as a ferro-magnetic annular core or as a slotted annular core that has an air gap for the Hall sensor. The Hall sensor or a measuring winding around the annular core or around part of the annular core is used to pick up an induced current or rapid current changes, such as are generated by way of example as a result of electric arc faults in the corresponding current path of the isolating switch.

The current sensor contains a sensor housing having a through-going opening and the current sensor or rather the annular core of the current sensor is arranged in relation to the through-going opening within the housing in a coaxial manner. In other words, the current sensor or rather the annular core of the current sensor is arranged within the housing in the region of the through-going opening in such a manner that the through-going opening and the opening of the current sensor or rather the annular core of the current sensor are in alignment with one another.

This embodiment of the current sensor renders it possible to attach or mount the current sensor on the isolating switch in a simple manner such that a cable that is conveying the current that is to be detected can be routed through the through-going opening in the sensor housing and the annular core directly, in other words without any bends and without the cable making contact with a printed circuit board or the like at the corresponding input connection or output connection (input terminal or output terminal) of the isolating switch.

The current sensor is therefore embodied in an advantageous manner as a modular component that is mechanically connected to the module housing of the isolating switch in such a manner that the through-going opening in the sensor housing and the annular core and also the input connector or output connector of the isolating switch are in alignment with one another so that the cable that is conveying the current can be routed in the normal manner to the corresponding connector of the isolating switch and can be contacted at the connector.

A device for evaluating the detected current and in particular for detecting electric arc faults is provided within the housing, in other words within the module housing of the isolating switch or of the sensor housing. For this purpose, the evaluating device is configured and provided in terms of switching and/or programming technology so as, by using the detected current or rather characteristics in particular rapid current changes that occur as a result of an electric arc fault, to detect in the current signal an electric arc fault that occurs in the photovoltaic system and where necessary to trigger the isolating switch.

The isolating switch is triggered in a suitable manner by way of a switching mechanism that is arranged in the module housing of the isolating switch and preferably can also be manually actuated, the switching mechanism acting upon at least one contact point in the corresponding current path of the isolating switch and opens the contact point in the event of the isolating switch being triggered. The switching mechanism is connected in an expedient manner by way of a drive to the device for evaluating the detected current. This drive is used in a suitable manner also for triggering the isolating switch remotely.

The modular isolating switch or rather the module housing of the modular isolating switch is configured so as to be coupled to a remote triggering module and/or an under-voltage module. Whereas the remote triggering module and/or the under-voltage module are configured and provided so as to be mounted laterally on the modular isolating switch and also in so doing are embodied in particular also so as to be mounted on a profile rail. The modular current sensor or rather the sensor housing of the modular current sensor is provided and configured so as to be mounted on a housing face (front face or rear face) of the isolating switch, the housing face being parallel to the profile rail. Whereas therefore the remote triggering module or under-voltage module is mounted laterally on the isolating switch, the current sensor is mounted on the front face or rear face of the isolating switch.

In a particularly advantageous embodiment, the isolating switch having the attached modular current sensor and the remote triggering module and also the under-voltage module are assembled in a modular manner to form a so-called fire brigade switch with integrated arc fault detection. As a consequence, the duration of assembly times and the number of components are reduced since additional profile rails, cabling, terminals and the like and also an additional cabling of the overvoltage protector and respectively an overvoltage triggering unit and/or of the remote triggering unit are not required. In fact, the modular construction renders it possible in a simple manner to provide an internal coupling of the respective additional modules and also a direct coupling to the isolating switch that is mounted or can be mounted by way of example on a profile rail. Furthermore, the modular construction renders it possible with respect to the additional modules at least with respect to their housing that like parts, their functions, in particular triggering functions, are coupled or can be coupled internally to the triggering mechanism of the isolating switch, the like parts having a similar outer form and merely a different construction of the internal housing.

The apparatus is suitable in general also for other direct current systems and in this respect likewise for the safe switching of the systems. The apparatus contains in turn an isolating switch having input connectors and output connectors, wherein the isolating switch contains a switching contact for isolating at least one current path between one of the input connectors and one of the output connectors, and wherein a current sensor is provided for mounting on the isolating switch. The preferably direct-display current sensor contains in particular an annular core for the contact-free detection of the current that is flowing by way of the current path or rather by way of the positive cable or the negative cable or to detect current changes.

Other features which are considered as characteristic for the invention are set forth in the appended claims.

Although the invention is illustrated and described herein as embodied in a device for the safe switching of a photovoltaic system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic diagram of an apparatus for the safe switching of a photovoltaic system having an isolating switch and a modular current sensor according to the invention;

FIG. 2 is a diagrammatic, perspective view of the apparatus in accordance with FIG. 1 with the current sensor module mounted on the isolating switch and with a connector cable routed by way of the current sensor module to the isolating switch and also with a remote triggering module mounted on the isolating switch;

FIG. 3 is a cross-sectional view of the apparatus in accordance with FIG. 2;

FIG. 4 is a plan view of the apparatus in accordance with FIG. 2; and

FIG. 5 is a plan view of a modular apparatus in accordance with FIG. 4 as a fire brigade switch with an additionally coupled module for triggering the under-voltage.

### DETAILED DESCRIPTION OF THE INVENTION

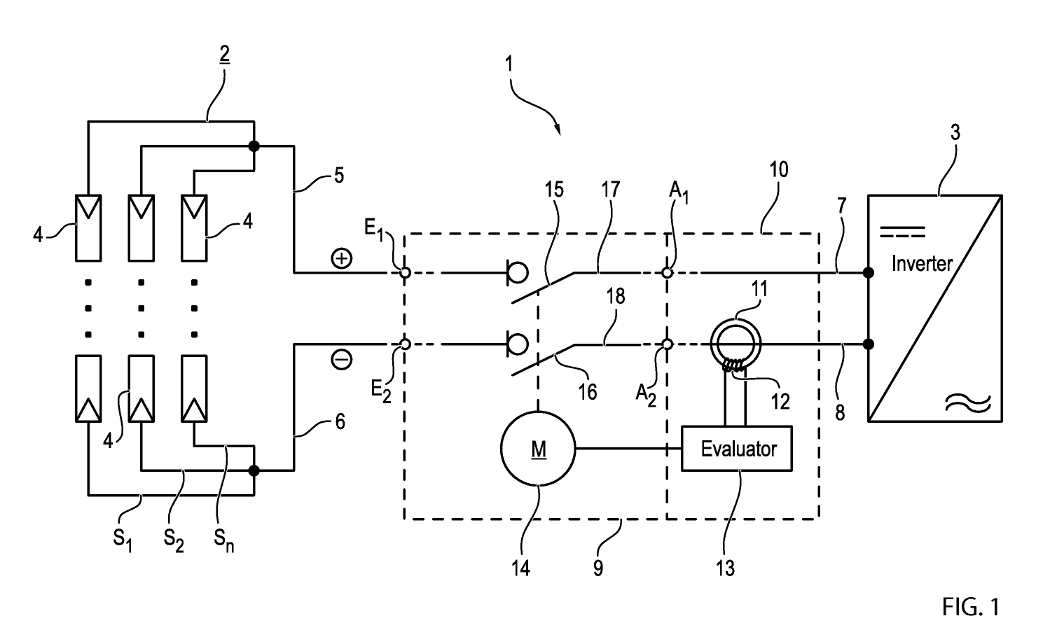

Parts that correspond with one another are provided in all the figures with like reference numerals. Referring now to the figures of the drawings in detail and first, particularly to FIG. 1 thereof, there is shown an apparatus 1 for the safe switching of a photovoltaic system 2 and an inverter 3. The photovoltaic system 2 contains a number of parallel connected strings S₁ to Sₙ each having a number of series connected photovoltaic modules 4. The parallel connected strings S₁ to Sₙ are connected by way of a common positive cable 5 to a first input (input connector) E₁ and by way of a negative cable 6 to a second input (input connector) E₂ of the apparatus 1. The apparatus 1 is connected on an output side by way of a first output (output connector) A₁ and a second output (output connector) A₂ to the inverter 3. The inverter 3 is connected for this purpose on the direct current side by way of a first connection cable 7 to the first output connector A₁ and by way of a second connection cable 8 to the second output connector A₂.

The apparatus 1 is modular and contains an isolating switch 9, referred to herein under as a switching module, and also a modular current sensor 10. The output connectors A₁ and A₂ are allocated to the isolating switch 9. The modular current sensor 10 contains an annular core 11 through which the connection cable 8 is routed to the output connector A₂ of the isolating switch 9.

The current sensor 10 contains in the exemplary embodiment a measuring winding or coil 12 having a number of windings wound around a part region of the annular core 11. The winding 12 is connected to a device 13 for evaluating the current and in particular for detecting an arc fault. The device 13 is in turn connected to a drive 14 that is coupled directly or indirectly to the switching contacts 15, 16 of the isolating switch 9. The switching contacts 15 are arranged in a current path 17 that is connected or rather allocated to the positive pole (+) of the photovoltaic system 2 and the current path runs between the input connector E₁ of the isolating switch 9 and the output connector A₁ of the isolating switch. The other switching contacts 16 are similarly connected in a current path 18 that is connected to the negative pole (−) of the photovoltaic system 2 and the current path runs between the second input connector E₂ of the isolating switch 9 and the second output connector A₂ of the isolating switch. The isolating switch 9 is embodied as a direct current isolator (DC-isolator) having the switching contacts 15 or 16 respectively that isolate both the positive current path 17 and also the negative current path 18.

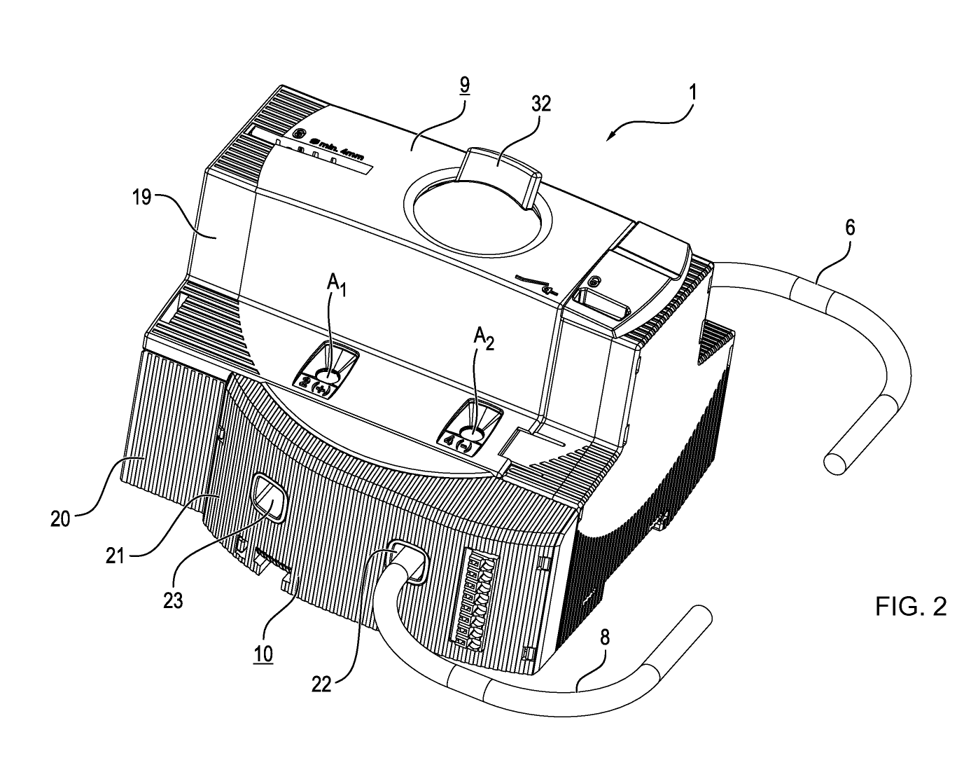

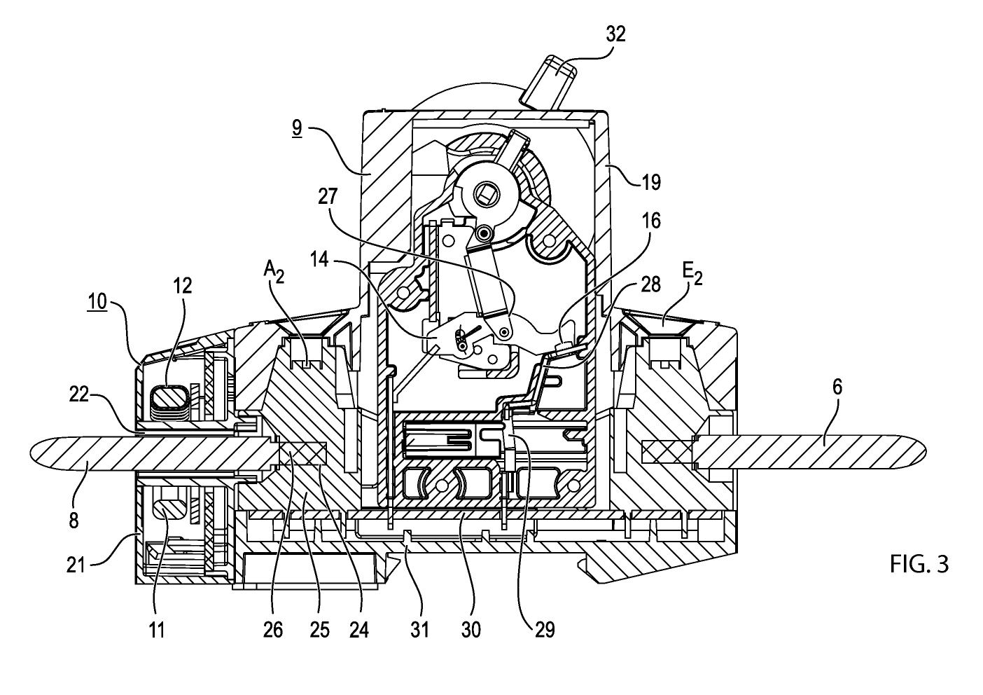

FIGS. 2 and 3 illustrate the modular apparatus 1 in a perspective view and a cross sectional view respectively. It is evident that the isolating switch 1 contains a module housing 19. The modular current sensor 10 together with a sensor housing 21 of the modular current sensor is arranged and mounted—preferably in a detachable manner—on a front face 20 of the module housing 19. The sensor housing 21 contains a through-going opening 22 that is aligned with the output connector A₂ of the isolating switch 9. The current-conveying connection cable 8 is routed through the through-going opening 22 of the modular current sensor 10 directly, in other words without bends, windings or further contact points to the output connector A₂ of the isolating switch 9 and contacts the output connector by way of example in a clamped or screwed manner. The sensor housing 21 of the current sensor 10 contains a further through-going opening 23 that is in turn aligned with the output connector A₁ of the isolating switch 9.

The annular core 11 having the measuring winding 12 is arranged within the sensor housing 21 in a coaxial manner with respect to the through-going opening 22 of the modular current sensor 10 or rather the sensor housing 21 of the current sensor. The annular core 11 is arranged in such a manner that the surrounded through-going opening of the annular core and the through-going opening 22 of the sensor housing 21 are aligned with a contact point 24 of a connection terminal 25 in order to contact the current-conveying connection cable 8 and thus the output connector A₂.

As is comparatively clear in FIG. 3, there are no bends in a connection end 26 of the connection cable, in other words the connection cable is routed directly through the through-going opening 22 and the annular core 11 of the current sensor 10 to the contact point 24, 25 and consequently to the output connector A₂.

The isolating switch 1 contains within the housing a switching mechanism 27 that acts on the contact point 16, in other words on the movable contact of the contact point and the movable contact for its part cooperates with a fixed contact that is arranged on a contact bridge 28 in order to form the contact point 16. The contact bridge 28 is electrically connected by way of a fail-safe element 29 to a circuit board 30. The circuit board 30 supports or is electrically connected to the device 13 for evaluating the current and detecting an electric arc fault, the device for its part being connected by way of a connector 31 to the switching mechanism 27 or rather to the drive 14 that is actuated by the switching mechanism. The switching mechanism 27 is in addition coupled by way of a switching or actuating lever 32 that extends out of the module housing 19 and is manually actuated for manually actuating the switching mechanism and accordingly the isolating switch 9.

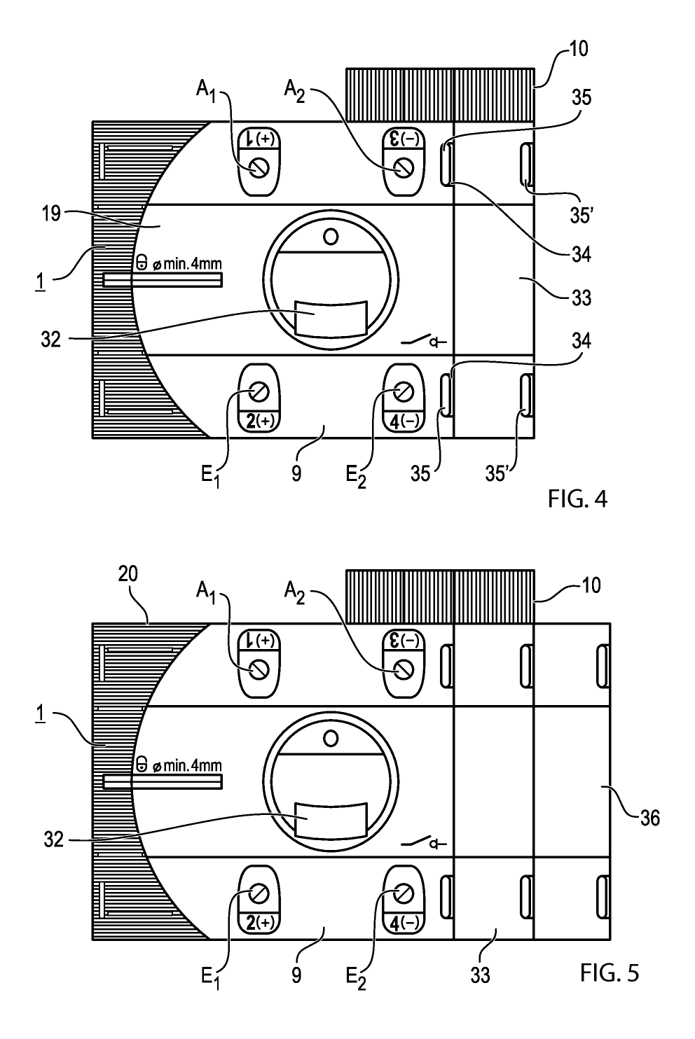

As is also evident in FIG. 4 that illustrates a plan view of the apparatus 1 in accordance with FIG. 2, the apparatus 1 is provided additionally with a module 33. For this purpose, the apparatus contains snap-in or latching elements 34 that correspond with corresponding snap-in or latching elements 35 of the module housing 19 of the isolating switch 9 for producing a detachable latching connection. The module 33 contains on the module face that lies opposite the latching elements 34 likewise latching recesses 35 for coupling a further module 36, as is illustrated in FIG. 5.

The module 33 is a remote trigger that is coupled internally to the drive 14 that acts on the switching mechanism 27 of the isolating switch 1. The remote triggering module 33 thus renders it possible to trigger the isolating switch 1 by way of example from a central office or the like.

The further module 36 is an under-voltage trigger that is coupled internally likewise to the drive 14 of the isolating switch 9. The under-voltage module 36 has a voltage that is below a predetermined threshold value and where necessary, for example by generating a corresponding triggering signal, separates or opens the contact points 15, 16 of the isolating switch 1.

As is particularly evident in FIG. 5, the additional module 33, 36 or each additional module 33, 36 of the apparatus 1 are mounted on the side of the apparatus and can be arranged in series one adjacent to the other virtually in any user-defined number with different functionalities. In contrast thereto, the current sensor 10 is arranged or rather mounted on the front faces 20 of the isolating switch 9.

The current sensor 10 can extend in accordance with FIG. 2 beyond the two adjacent output connectors A₁ and A₂ or also in accordance with FIGS. 4 and 5 only in the region of one of the output connectors A₁, A₂. In addition, the current sensor 10 can be arranged on the opposite-lying front or rear face 20 of the isolating switch 10 in the region of the input connectors E₁, E₂, or E₁ and E₂ respectively. In the embodiment in accordance with FIG. 2, the current sensor 10 can also contain two annular cores 11, in other words one annular core 11 for each current path 17, 18.

The current sensor 10 can be embodied fundamentally in accordance with a type of Rogowski coil, as a ferritic annular core having a measuring or coil winding 12 or as a direct-display current sensor. The current sensor can be embodied a slotted annular core having a Hall sensor arranged in the air gap formed thereby in lieu of the measuring winding 12.

The following is a summary list of reference numerals and the corresponding structure used in the above description of the invention:
1 Apparatus
2 Photovoltaic system
3 Inverter
4 Photovoltaic module
5 Positive cable
6 Negative cable
7 Connection cable
8 Connection cable
9 Isolating switch
10 Current sensor
11 Annular core
12 Coil/Measuring winding
13 Device
14 Drive
15 Switching contact
16 Switching contact
17 Current path
18 Current path
19 Module housing
20 Front/Rear face
21 Sensor housing
22 Through-going opening
23 Through-going opening
24 Contact point
25 Connection terminal
26 Connection end
27 Switching mechanism
28 Contact bridge
29 Fail-safe element
30 Circuit board
31 Connector
32 Switching/Actuating lever
33 Remote triggering module
34 Latching element
35 Latching element
36 Under-voltage module
A_{1,2} Output connector
E_{1,2} Input connector
S_{1 . . . n} String

1. An apparatus for a safe switching of a photovoltaic system, the apparatus comprising:
an isolating switch having input connectors for connecting to a number of mutually connected photovoltaic modules and output connectors for connecting to an inverter, said isolating switch being a switching module having a module housing and a switching contact for isolating at least one current path between one of said input connectors and one of said output connectors, said switching contact disposed in said module housing; and
a modular current sensor for detecting a current flowing along said current path and mounted on said module housing.

2. The apparatus according to claim 1, wherein said modular current sensor detects the current in a contact-free manner.

3. The apparatus according to claim 1, further comprising a device that is allocated to said modulated current sensor or to said isolating switch, said device being provided for evaluating a detected current, including for detecting an electric arc fault.

4. The apparatus according to claim 1, wherein said modulated current sensor has a sensor housing having a through-going opening formed therein and an annular core that is provided within said sensor housing in a coaxial manner, wherein in an assembled state on said isolating switch said through-going opening of said sensor housing is aligned with one of said input connectors or with one of said output connectors.

5. The apparatus according to claim 4, further comprising a connection cable that is in contact respectively with said at least one of said input connectors or with at least one of said output connectors of said isolating switch and passes through said through-going opening of said sensor housing and said modulated current sensor or rather said annular core of said modulated current sensor.

6. The apparatus according to claim 1, wherein said isolating switch contains a manually actuated switching mechanism.

7. The apparatus according to claim 1, wherein said isolating switch isolates both a positive current path and also a negative current path.

8. The apparatus according to claim 1, wherein said isolating switch is embodied so as to be mounted on a profile rail.

9. The apparatus according to claim 1, wherein said isolating switch has an input side and an output side, said modular current sensor is mounted on at least one of said input side or said output side of said isolating switch.

10. The apparatus according to claim 1, wherein said isolating switch is configured for coupling a module so as to facilitate a remote triggering operation and/or an under-voltage triggering operation.

11. The apparatus according to claim 10, wherein the module is configured so as to facilitate respectively the remote triggering operation or the under-voltage triggering operation.

12. A fire brigade switch, comprising:
an apparatus according to claim 1; and
a module for facilitating at least one of a remote triggering operation or an under-voltage triggering operation.

13. An apparatus for a safe switching of a DC-current system, the apparatus comprising:
an isolating switch having input connectors and output connectors, said isolating switch further having a switching contact for isolating at least one current path between one of said input connectors and one of said output connectors; and
a current sensor mounted on said isolating switch.

14. The apparatus according to claim 13, wherein said current sensor is a direct-display current sensor having an annular core for detecting in a contact-free manner a current that is flowing along said current path or to detect current changes.
